(19) United States
(12) Patent Application Publication
(10) Pub. No.: US 2011/0137521 A1
(43) Pub. Date: Jun. 9, 2011

(54) VEHICULAR TRAFFIC ENFORCEMENT SYSTEM

(76) Inventor: NISIM LEVI, Jerusalem (IL)

(21) Appl. No.: 12/951,124

(22) Filed: Nov. 22, 2010

(30) Foreign Application Priority Data
Dec. 6, 2009 (IL) IL 202521

(51) Int. Cl. G06F 7/00

(52) U.S. Cl. 701/36

(57) ABSTRACT

A vehicular enforcing system comprising a display unit mounted on a vehicle for displaying information regarding to allowed/forbidden operation of said vehicle, said display unit being viewable from outside of said vehicle); at least one sensor, for sensing data related to said information; and a controller configured to obtain said data from said at least one sensor, and display said information on said display unit.

### CROSS-REFERENCE TO RELATED APPLICATIONS

The current application claims the benefit of priority from Israel Patent Application No. 202,521, filed Dec. 6, 2009, whose disclosure is incorporated herein by reference.

### FIELD OF THE INVENTION

The present invention relates to the field of vehicle traffic enforcement. More particularly, the invention relates to a system and a method for displaying travelling information of a vehicle for traffic enforcement purposes.

### BACKGROUND OF THE INVENTION

Vehicle accidents are relatively common everywhere, and may result in property damage, injury and even death. Vehicle accidents may involve collisions with other vehicles, with pedestrians, and with stationary objects such as trees, lamp posts, road barriers, building structures, among others.

Speed is one of the leading causes of vehicle accidents. Studies have shown that many accidents involve relatively young drivers, for example, between the ages of 17-25. Occasionally, the vehicles include more passengers than permitted by law, which increases a risk of bodily injury, or even death, to the passengers in case of an accident.

Vehicle traffic enforcement to control speeding generally relies on the use of detection devices such as laser and radar devices. This requires that each traffic enforcement vehicle (e.g. police vehicle) be equipped with one of these devices, which generally is not possible due to a relatively high cost of the device. Furthermore, for those police vehicles equipped with a device, the vehicle is generally required to be in a stationary position in front of the speeding car in order to obtain an accurate speed measurement. This may cause a problem for traffic enforcement agents (e.g. police officers) in moving vehicles as their inability to obtain an accurate speed measurement while moving may restrict them from stopping a speeding vehicle.

It is an object of the present invention to provide a solution to the above-mentioned and other problems of the prior art.

Other objects and advantages of the invention will become apparent as the description proceeds.

### SUMMARY OF THE INVENTION

There is provided, in accordance with an embodiment of the present invention, a vehicular enforcing system (2) comprising a display unit (4) mounted on a vehicle (34) for displaying information regarding to allowed/forbidden operation of the vehicle (34), the display unit (4) being viewable from outside of the vehicle (34); at least one sensor (40/42/44), for sensing data related to the information; and a controller (38) configured to obtain the data from the at least one sensor (40/42/44), and display the information on the display unit (4). Optionally, the information regarding to allowed/forbidden operation of the vehicle (34) comprises a speed of the vehicle (34) and a number of passengers in the vehicle (34). Additionally or alternatively, controller (38) communication with the display unit (4) is wireless.

In some embodiments of the present invention, the display unit (4) is configured to be mounted in an interior of the vehicle (34). Optionally, the interior of the vehicle (34) comprises a window (31/36/37) of the vehicle (34). Optionally, the display unit (4) is configured to be mounted on an outside of the vehicle (34). Optionally, the outside of the vehicle is a rear section (35) of the vehicle.

In some embodiments of the present invention, the sensor (40/42/44) is a speedometer (42) for sensing a speed of the vehicle (34). Optionally, the sensor (40/42/44) is a vehicle computer (40) for sensing a speed of the vehicle (34). Optionally, the sensor (40/42/44) is a contact sensor (44) for sensing a person seating on a vehicle seat There is provided, in accordance with an embodiment of the present invention, a method for enforcing vehicular safety comprising: sensing data related to allowed/forbidden operation of a vehicle (34); processing the sensed data into information regarding to allowed/forbidden operation of the vehicle (34); and displaying the information such that it is viewable from outside the vehicle (34). Optionally, the information regarding to allowed/forbidden operation of the vehicle (34) comprises a speed of the vehicle (34) and a number of passengers in the vehicle (34). Additionally or alternatively, the method further comprises communicating through wireless means between a controller (38) and a display unit (4).

In some embodiments of the present invention, the method comprises mounting a display unit (4) in an interior of the vehicle (34). Optionally, the interior of the vehicle (34) comprises a window (31/36/37) of the vehicle (34). Optionally, the method comprises mounting a display unit (4) on an outside of the vehicle (34). Additionally or alternatively, the outside of the vehicle (34) is a rear section (35) of the vehicle (34).

In some embodiments of the present invention, the method further comprises sensing a speed of the vehicle (34) from a speedometer (42). Optionally, the method further comprises sensing a speed of the vehicle (34) from a vehicle computer (40). Optionally, the method further comprises sensing a person seating on a vehicle seat (46).

The foregoing embodiments of the invention are described and illustrated in conjunction with systems and methods thereof, which are meant to be merely illustrative, and not limiting.

### BRIEF DESCRIPTION OF THE DRAWINGS

Embodiments and features of the present invention are described herein in conjunction with the following drawings:

FIG. 1 schematically illustrates a perspective view of an exemplary display unit included in an exemplary vehicular enforcing system, in accordance with an embodiment of the present invention;

FIG. 2 schematically illustrates a perspective view of a rear side of the display unit of FIG. 1, in accordance with an embodiment of the present invention;

FIG. 3 schematically illustrates a perspective view of an exemplary vehicle including the display unit of FIG. 1, in accordance with some embodiments of the present invention; and

FIG. 4 schematically illustrates the vehicular enforcing system inside the vehicle of FIG. 3, in accordance with some embodiments of the present invention.

It should be understood that the drawings are not necessarily drawn to scale.

### DETAILED DESCRIPTION OF THE INVENTION

The present invention will be understood from the following detailed description of preferred embodiments, which are meant to be descriptive and not limiting. For the sake of brevity, some well-known features, methods, systems, procedures, components, circuits, and so on, are not described in detail.

An aspect of some embodiments of the present invention relates to a vehicular enforcing system for displaying information regarding allowed and/or forbidden operation of a vehicle in which the system is installed, such that the displayed information may be viewed by a person externally located with respect to the vehicle. Displaying the information so that it may be viewed from outside the vehicle may allow traffic enforcement agents to control cars which violate traffic laws without using detection devices. Furthermore, an only requirement may be that the police officer be within a field of view of the displayed information.

Such a system may contribute to substantial savings to police forces by reducing cost expenditures in detection devices, and may further assist the forces in enforcing traffic laws and combating traffic accidents. Furthermore, a driver who is aware that information related to allowed/forbidden operation of the vehicle is viewable from outside of the vehicle may be more inclined to obey the traffic laws, possibly contributing to a further reduction in traffic accidents.

In some embodiments of the present invention, the displayed information may include a speed of the vehicle and a number of passengers inside the vehicle. Optionally, other information may be displayed as pertinent to vehicle safety, for example, a final inspection date of the vehicle, indication that the driver is a new driver, indication of the driver's experience, and the like. Optionally, special alert methods may be used to indicate high speeds or more passengers than allowed for example, by a flashing display of the information, by use of colors (e.g. red), and the like. Optionally, historical data may be displayed, on-demand (for example, when recalled from a memory) which may include past speeds in excess of a specified limit (speed infractions), number of passenger above a specified maximum (passenger infractions), the dates of the infractions, or any other relevant information as may be appropriate to monitor and control vehicle traffic safety.

In some embodiments of the present invention, the information is displayed on a display unit mounted inside the vehicle which may be viewed from outside the vehicle. Optionally, the display unit is mounted externally to the vehicle attached to an outside of the vehicle. Optionally, the display unit may be located internally or externally in a rear section of the vehicle. Additionally or alternatively, the display unit may be located in other sections of the vehicle so that the information may be viewed from more than one direction (for example, may also be located on the sides and/or in the front).

In some embodiments of the invention, vehicle enforcing system includes a controller for processing the information. The controller may receive an input such as the speed of the vehicle from the vehicle's computer and/or speedometer, and may receive an input from a sensor responsive to a pressure exerted by a sitting passenger. The input information is processed by the controller and communicated to the display unit for display. Communications between the display unit and the controller may be through a hard-wired connection. Optionally, the communications may be through a wireless connection, such as for example, as in a wireless network, or any combination of different wireless networks, generally conforming to IEEE Standards 802.11 (Wireless LAN—WiFi). Optionally, the WLAN may conform to IEEE Standards 802.15 (Wireless PAN—WPAN), 802.16 (Broadband Wireless Access—WiMAX), 802.20 (Mobile Broadband Wireless Access—MBWA), and/or 802.22 (Wireless Regional Area Network—WRAN), or any combination thereof. Optionally, communications between the components (controller, sensor, display, speedometer, vehicle computer) of the vehicular enforcing system and/or the vehicle may be hard-wired, wireless (as above), or any combination thereof.

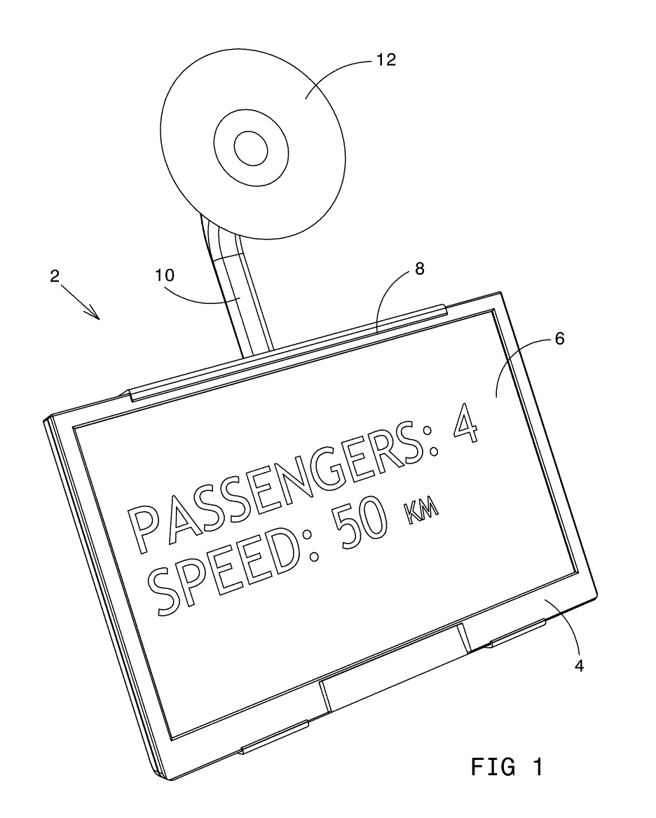

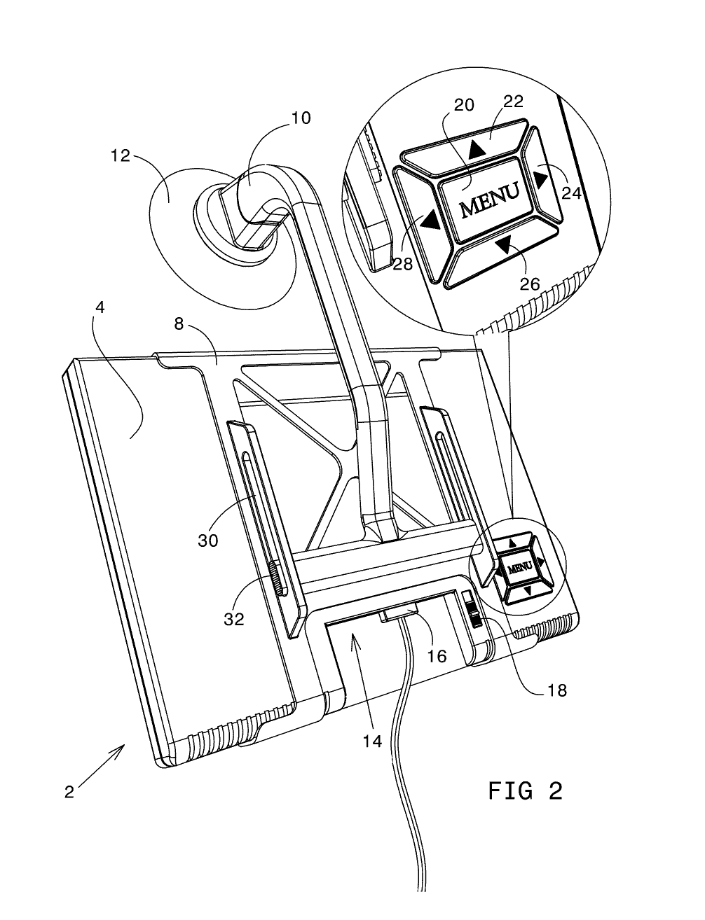

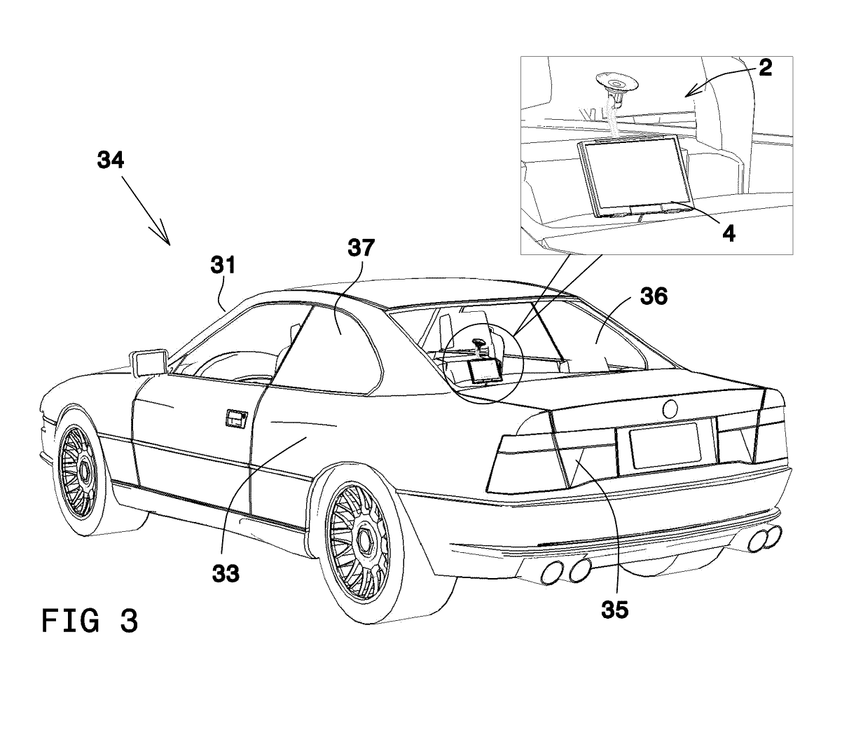

Reference is now made to FIGS. 1 and 2 which schematically illustrate a perspective view and a perspective rear view, respectively, of an exemplary display unit 4 included in an exemplary vehicular enforcing system 2, in accordance with an embodiment of the present invention. Reference is also made to FIG. 3 which schematically illustrates a perspective view of an exemplary vehicle 34 including display unit 4, in accordance with some embodiments of the present invention. Display unit 4 is configured to display information regarding allowed/forbidden operation of vehicle 34, and includes an alphanumeric display 6 for displaying the information. As previously stated, this information may include a speed of vehicle 34, and a number of passengers in the vehicle.

In some embodiments of the present invention, display 6 may be of a sufficiently large size to be easily viewed by a person with normal eyesight (20/20) external to vehicle 34. For example, an FOV of display 6 may allow the person to clearly see the information displayed up to a distance of 100 m from the display, for example, up to 75 m, up to 50 m, up to 25 m, up to 10 m. Optionally, display 6 may be seen by the person as a distance greater than 100 m. Optionally, an angle of view may range from −80° to 80°, for example, −60° to 60°, −40° to 40, −20° to 20. Optionally, display 6 may include a color display which may serve to attract the viewer's attention. Additionally or alternatively, display 6 may include a flashing display to attract a viewer's attention. For example, display 6 may flash or may change colors when a speed limit is surpassed or a maximum number of allowed passengers is exceeded. Optionally, display 6 includes lighting or other features suitable for night time viewing of the display.

In some embodiments of the present invention, display unit 4 is mounted inside a passenger section of vehicle 34 where it may be attached to a rear window 36, a side window 37, a front window 31, or any combination thereof (using a plurality of display units). Attachment of display unit 4 to the window, for example rear window 36, may include a flexible arm support 10 which connects at a first end to a display unit support frame 8, and at a second end to a suction cup 12 which attaches to the window. Support frame 8 optionally attaches to display unit 4 from a back side of the unit, and allows display unit 4 to be positioned at different heights along a length of flexible arm support 10. For example, support frame 8 may include two rails 30 configured to allow the display unit to be slidably displaced to the different heights. A release button 32 may be used to release a secured position of display unit 4 along rail 30 so that the height may be adjusted. Suction cup 12 may be configured to remain attached to the window while supporting a combined weight of flexible arm support 10, support frame 8, and display unit 4. Optionally, flexible arm support 10 may be attached at the second end to a mounting plate which may be attached by screws, adhesive, or any other suitable means of attachment, to a window, for example window 36. Optionally, flexible arm support 10 is attached to a supporting member inside the passenger section other than a window.

In some embodiments of the present invention, display unit 4 is further configured to operationally withstand a vibration and shock environment to which vehicle 34 may be exposed during its lifetime. When a use of display unit 4 is limited solely to an interior of vehicle 34 (for example, inside the passenger section), the display unit may optionally be configured to operationally withstand other environmental conditions (e.g. humidity, temperature, and the like) typically found in the passenger section of the vehicle. Optionally, for use outside vehicle 34, display unit 4 may be configured to operationally withstand outdoor environmental conditions typically encountered by the vehicle which may include, aside from those previously mentioned, rain, snow, dust, subzero temperatures, relatively high temperatures (as may be encountered in hot countries), and the like.

As previously mentioned, display unit 4 may be attached to the exterior of vehicle 34, for example on a rear section 35 of the vehicle. Optionally, display unit 4 may be mounted on a side 33 or on the front (not shown) of vehicle 34, or any combination thereof (using a plurality of display units). Optionally, attachment of display unit 4 to the exterior of vehicle 34 may be a fixed attachment which may require use of an attachment tool to remove the display unit. Additionally or alternatively, display unit 4 is removably affixed to the outside of vehicle 34 so that the display unit may be readily removed without use of a tool.

In some embodiments of the present invention, display unit 4 includes an activation switch 18 for switching power on and off in the display unit. Power supply to the display unit may be through a hard-wired connection to a connector 36, the power optionally coming directly, or indirectly, from a battery (not shown) of vehicle 34. Optionally, the power may come from an alternate battery source (not shown). Additionally or alternatively, the connection through connector 36 is from an electrical system (not shown) of vehicle 34. Optionally, connector 36 serves to provide a hard-wire connection for display unit 4 for receiving the information to be displayed regarding the allowed/forbidden operation of vehicle 34. Optionally, the information is received through a wireless receiver 14.

In some embodiments of the present invention, display unit 4 may include menu-driven programming of display 6 which may be done by a user by pressing on a menu button 20 on a back side of the unit. Optionally, menu button 20 may be located on a front side of display unit 4 or at another location on the display unit. Menu button 20 may serve to select font types and sizes, colors, attention-catching features (for example, flashing), and the like. Optionally, menu button 20 may serve to interface with a controller (not shown), to be described in more detail further on below, configured to process input information, including speed and number of passenger information, and output the information regarding allowed/forbidden operation of vehicle 34. Navigation throughout the one or menus may be done by pressing on up navigation button 22, right navigation button 24, down navigation button 26, and left navigation button 28.

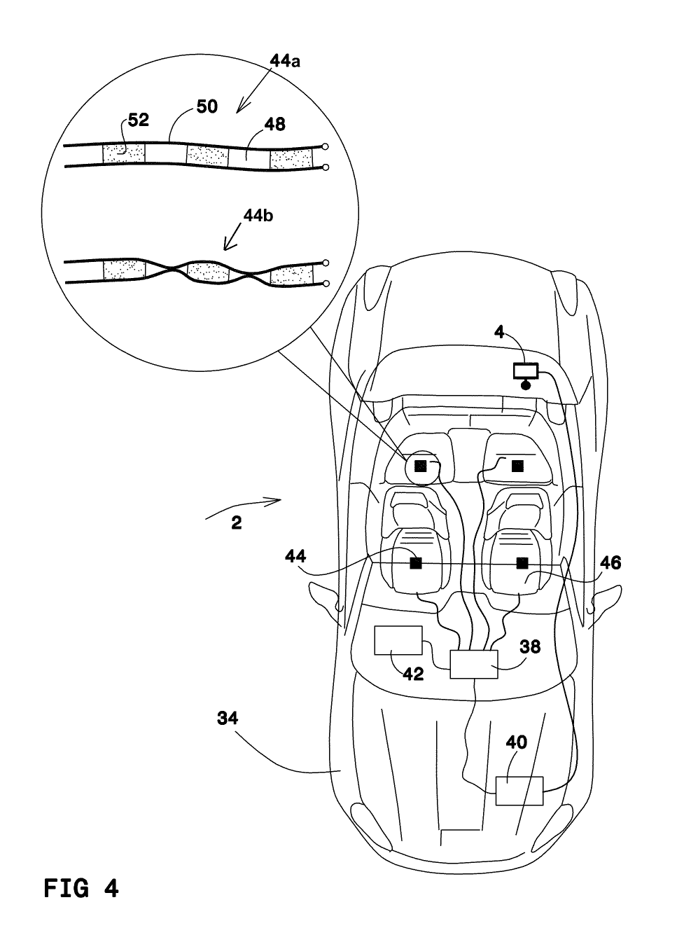

Reference is now also made to FIG. 4 which schematically illustrates vehicular enforcing system 2 inside vehicle 34, in accordance with some embodiments of the present invention. Vehicular enforcing system 2 is configured to monitor a travelling speed of vehicle 34 and a number of passenger in the vehicle, and to display the information on display unit 4 such that the information may be viewed outside of the vehicle while in travel. System 2 may be additionally configured to process other information inputs and to display the processed information on display unit 4. Optionally, the displayed information is other vehicle safety information related to vehicle 34 and/or its driver.

Vehicular enforcing system 2 in vehicle 34 additionally includes a controller 38 which receives speed information from the vehicle's speedometer 42, optionally from the vehicle's computer 40, and processes the information for displaying speed information on display unit 4. Vehicular enforcing system 2 additionally includes a contact sensor 44 located in each vehicle seat 46 in the vehicle, the sensors configured to send a signal to controller 38 upon sensing pressure associated with a person seating in the vehicle seat. Responsive to the signal from sensor 44, controller 38 processes the information for displaying a number of passengers seating in vehicle 34 on display unit 4. Optionally, sensing of a seating person may include other methods of sensing, for example, optically sensing a sitting person. Optionally, each seat 46 may include a switch which sends a signal when a person sits on the seat.

In some embodiments of the present invention, communications between controller 38 and display 4 may be through hard-wired means and/or wireless means as previously disclosed. Optionally, communications between controller 38 and sensors 44, speedometer 42, vehicle computer 40, in any combination thereof, may be through hard-wired means and/or wireless means, as previously disclosed.

In some embodiments of the present invention, controller 38 may be a separate unit in vehicular enforcing system 2, and may be separately programmable through a controller interface (not shown). Optionally, controller 38 may be programmable through display unit 4 by navigating using buttons 20, 22, 24, 26 or 28, or any combination thereof, through menus displayed on display unit 4. Optionally, information may be accessed from controller 38 by navigating through the menus.

In some embodiments of the present invention, controller 38 may include memory storage (not shown) for storing historical data. Optionally, the historical data may be recalled on-demand by a user, for example by navigating through the menus displayed on display unit 4. Optionally, other data may be stored as may be input by a user. Additionally or alternatively, the memory storage is in display unit 4. Optionally, controller 38 is included in display unit 4.

Reference numerals 44a and 44b schematically illustrate seat contact sensor 44 in a non-conducting mode (open circuit) and conducting mode (short circuit), respectively, in accordance with some embodiments of the present invention. Sensor 44 may include two strips of conducting foils 50 with an isolation material 52 between them, the isolation interspaced with air cavities 48 along a length of the two conducting foils. Isolation 52 may be a soft resilient material which when pressure is exerted on foils 50, the isolation compresses allowing the two strips of foil to come into contact at cavities 48 forming a short circuit. The short circuit is sensed by controller 38 which processes this information as a person seating on vehicle seat 46. When pressure is removed from sensor 44, isolation 52 returns to an uncompressed state and the two strips of foil 50 separate to form an open circuit. The open circuit is sensed by controller 38 which processes this information as vehicle seat 46 being vacant.

In the figures and/or description herein, the following reference numerals have been mentioned:

| Part Description | Number |
|---|---|
| Vehicle Enforcement System | 2 |
| Display unit | 4 |
| Display screen | 6 |
| Support frame | 8 |
| Flexible arm support | 10 |
| Fastener | 12 |
| Wireless receiver | 14 |
| Connector | 16 |
| Activation switch | 18 |
| Menu button | 20 |
| Up navigation button | 22 |
| Right navigation button | 24 |
| Down navigation button | 26 |
| Left navigation button | 28 |
| Rail | 30 |
| Front vehicle window | 31 |
| Release mechanism | 32 |
| Vehicle side | 33 |
| Vehicle | 34 |
| Vehicle rear | 35 |
| Rear vehicle window | 36 |
| Side vehicle window | 37 |
| Controller | 38 |
| Vehicle computer | 40 |
| Vehicle speedometer | 42 |
| Sensor | 44 |
| Vehicle seat | 46 |
| Cavity | 48 |
| Conducting foil | 50 |
| Isolation | 52 |

The foregoing description and illustrations of the embodiments of the invention has been presented for the purposes of illustration. It is not intended to be exhaustive or to limit the invention to the above description in any form.

Any term that has been defined above and used in the claims, should to be interpreted according to this definition.

What is claimed is:

1. A vehicular enforcing system, comprising:
a display unit mounted on a vehicle for displaying information regarding to allowed/forbidden operation of said vehicle, said display unit being viewable from outside of said vehicle;
at least one sensor, for sensing data related to said information; and
a controller configured to obtain said data from said at least one sensor, and display said information on said display unit.

2. The system of claim 1 wherein the information regarding to allowed/forbidden operation of said vehicle comprises a speed of the vehicle and a number of passengers in the vehicle.

3. The system of claim 1 wherein the display unit is configured to be mounted in an interior of the vehicle.

4. The system of claim 3 wherein the interior of the vehicle comprises a window of said vehicle.

5. The system of claim 1 wherein the display unit is configured to be mounted on an outside of the vehicle.

6. The system of claim 5 wherein the outside of the vehicle is a rear section of said vehicle.

7. The system of claim 1 wherein the sensor is a speedometer for sensing a speed of said vehicle.

8. The system of claim 1 wherein the sensor is a vehicle computer for sensing a speed of said vehicle.

9. The system of claim 1 wherein the sensor is a contact sensor for sensing a person seating on a vehicle seat.

10. The system of claim 1 wherein controller communication with the display unit is wireless.

11. A method for enforcing vehicular safety comprising:
sensing with at least one sensor data related to allowed/forbidden operation of a vehicle;
processing with a controller the sensed data from the sensor into information regarding to allowed/forbidden operation of the vehicle for displaying on a display unit; and
displaying the information with the display unit such that it is viewable from outside the vehicle.

12. The method of claim 11 wherein the information regarding to allowed/forbidden operation of said vehicle comprises a speed of the vehicle and a number of passengers in the vehicle.

13. The method of claim 11 comprising mounting the display unit in an interior of the vehicle.

14. The method of claim 13 wherein the interior of the vehicle comprises a window of said vehicle.

15. The method of claim 11 comprising mounting the display unit on an outside of the vehicle.

16. The method of claim 15 wherein the outside of the vehicle is a rear section of said vehicle.

17. The method of claim 11 wherein the at least one sensor is a speedometer.

18. The method of claim 11 wherein the at least one sensor is a vehicle computer.

19. The method of claim 11 further comprising sensing a person seating on a vehicle seat.

20. The method of claim 11 further comprising communicating through wireless means between the controller and a display unit.
